(19) United States
(12) Patent Application Publication
(10) Pub. No.: US 2026/0027882 A1
(43) Pub. Date: Jan. 29, 2026

(54) ELECTRIC VEHICLE STRUCTURE

(71) Applicant: FCA US LLC, Auburn Hills, MI (US)

(72) Inventors: Travis D Bechtel, Auburn Hills, MI (US); Mark E Stout, Auburn Hills, MI (US)

(21) Appl. No.: 18/787,060

(22) Filed: Jul. 29, 2024

(51) Int. Cl. B60K 1/04; B62D 21/03; B62D 25/02; B62D 25/20; B62D 29/00

(52) U.S. Cl. CPC B60K 1/04; B62D 21/03; B62D 25/025; B62D 25/2009; B62D 29/00; B60K 2001/0438

(57) ABSTRACT

A vehicle includes a first inner frame member, a second inner frame member spaced apart from the first inner frame member and a lower battery plate coupled between the first inner frame member and the second inner frame member. A plurality of top chassis cross members is supported by the first inner frame member and the second inner frame member. A battery disposed between the first inner frame member, the second inner frame member, the lower battery plate and the plurality of top chassis cross members. A first outer rocker member is adjacent to and outboard of the first inner frame member. A second outer rocker member is adjacent to and outboard of the second inner frame member. A floor deck plate is supported by the top chassis cross member.

### FIELD

The present disclosure relates generally to an electric vehicles and, more specifically, to an electric vehicle structure for a flexible design configured to allow maximum flexibility during assembly and in servicing.

### BACKGROUND

This section provides background information related to the present disclosure which is not necessarily prior art.

Electric vehicles do not have an internal combustion engine. Electric vehicles have batteries that are used to power electric motors which turn the wheels to provide a motive force. Light commercial vehicles (LCVs) are vehicles designed for long utility life. Examples of LCVs are short haul delivery vehicles.

Currently, most battery electric-powered commercial vehicles are modified versions of ICE platforms with a battery added to them after initial design. This is evident in that these platforms have a chassis that is constructed to support their rated cargo carrying capacity and crash safety requirements, and a separate battery pack structure in which the battery cells are packaged that is capable of protecting the battery in the event of a crash. The structures (chassis and battery pack) do not provide any mutual protection or chassis performance for one another, and both occupy significant packaging space, resulting in a vehicle platform which is taller and heavier than optimal. Battery packs must often be removed from the vehicle entirely to be serviced, which does not lend support to having a low total cost of ownership and quick repair/low down time requirements for LCV customers.

The material and processes chosen to construct the chassis are relevant to the weight of a vehicle. Steel is the most common material choice in current production, due to its high strength and relatively low-cost position. Steel construction is typically achieved with multiple stamped or drawn components welded into assemblies. The assembly is chemically cleaned and coated with materials to achieve the desired lifespan for resistance to corrosion in the vehicle application.

A commercial vehicle chassis architecture is often tasked with efficiently providing multiple size configurations for variables such as wheelbase and rear overhang. Commercial chassis must be flexible to accommodate an open cargo area for custom bolt on body such as recreational vehicle or specialized service body. Likewise, a closed cargo body with no passengers and a multi-passenger configuration may also need to be accommodated. The variations can drive large tooling and fixturing costs as well as occupy significant manufacturing floor space.

### SUMMARY

This section provides a general summary of the disclosure, and is not a comprehensive disclosure of its full scope or all of its features.

The vehicle construction allows a flexible design configured to allow maximum flexibility in an easy assembly.

In one aspect of the disclosure, a vehicle includes a first inner frame member, a second inner frame member spaced apart from the first inner frame member and a lower battery plate coupled between the first inner frame member and the second inner frame member. A plurality of top chassis cross members is supported by the first inner frame member and the second inner frame member. A battery disposed between the first inner frame member, the second inner frame member, the lower battery plate and the plurality of top chassis cross members. A first outer rocker member is adjacent to and outboard of the first inner frame member. A second outer rocker member is adjacent to and outboard of the second inner frame member. A floor deck plate is supported by the top chassis cross member.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a vehicle having the vehicle architecture of the present disclosure.

FIG. 2A is a perspective view illustrating the floor deck plates of the chassis of the vehicle with one deck plate removed to show the structure below.

FIG. 2B is a perspective view of the vehicle with the floor deck plates removed.

FIG. 2C is a cross-sectional view of the vehicle through the battery.

FIG. 2D is an enlarged cross-sectional view of the right portion of the vehicle.

FIG. 2E is an enlarged cross-sectional view of the vehicle body joined to the rocker panel.

### DETAILED DESCRIPTION

Example embodiments will now be described more fully with reference to the accompanying drawings.

The present vehicle design uses continuous elongated forms to provide flexibility in assembling multiple types of vehicles. Utilizing continuous profiles of steel would likely be realized with a roll forming process to create the basic sections and adding bending or hydroforming secondary processes to meet desired chassis geometry requirements. Non-ferrous materials can be desirable for potential mass reduction and resistance to corrosion with or without anti-corrosion processes. Reinforced fiber composites, and specific grades of aluminum and magnesium can be suitable replacements for steel.

To address the tooling expense and the variants in wheelbase and rear overhang lengths, extruded profiles can be cut to different lengths to reduce the quantity of tools needed. Extrusion tools themselves are also relatively inexpensive depending on the material to be formed and can provide differences in internal geometry for a given external shape/size. This benefit can be used to reduce assembly process complexity and optimize material cost and weight to the performance needed.

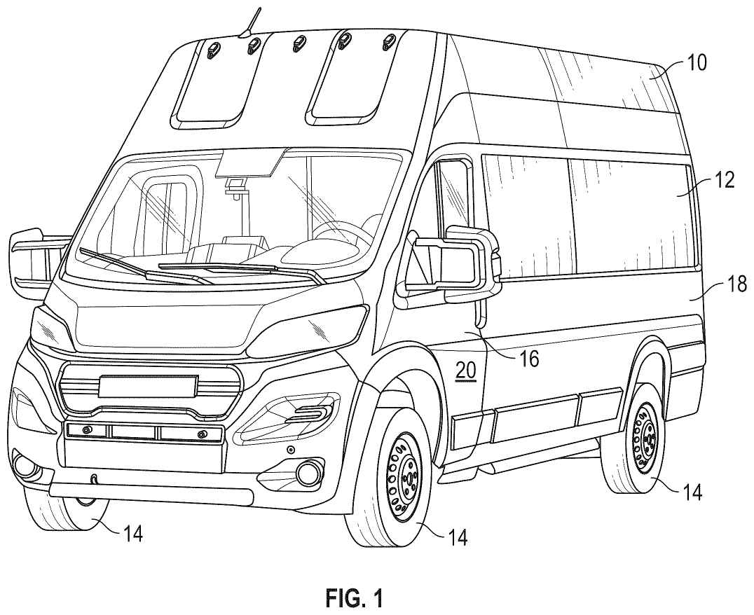

Referring now to FIG. 1, a vehicle 10 having a body 12 is illustrated. In this example, the vehicle 10 is a light commercial vehicle (LCV). However, the construction of the present vehicle 10 may be used for several types of vehicles. The vehicle 10 has a tire and wheel assembly 14 at each corner of the vehicle and is coupled to the inner instruction as will be described in greater detail below.

The body 12 has a passenger compartment 16 and a cargo compartment 18. The passenger compartment 16 and the cargo compartment 18 may be integrally formed into the body 12. As will be described in greater detail below, the passenger compartment 16 may be formed from different materials than the cargo compartment for greater passenger protection. The vehicle 10 is illustrated having doors 20 that are used for the passengers to access the passenger compartment 16. Seats and other components, not shown, are used to secure the passengers in place.

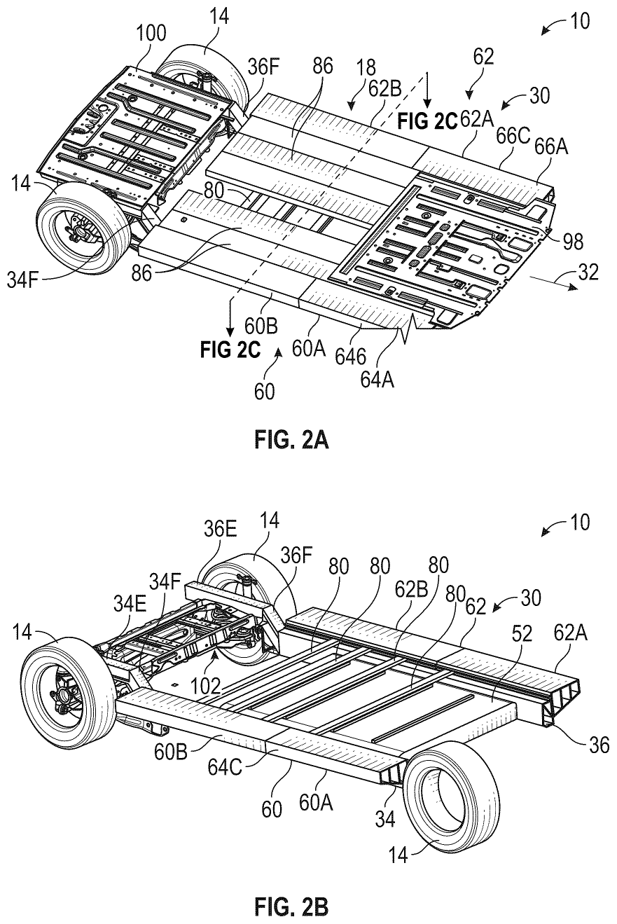

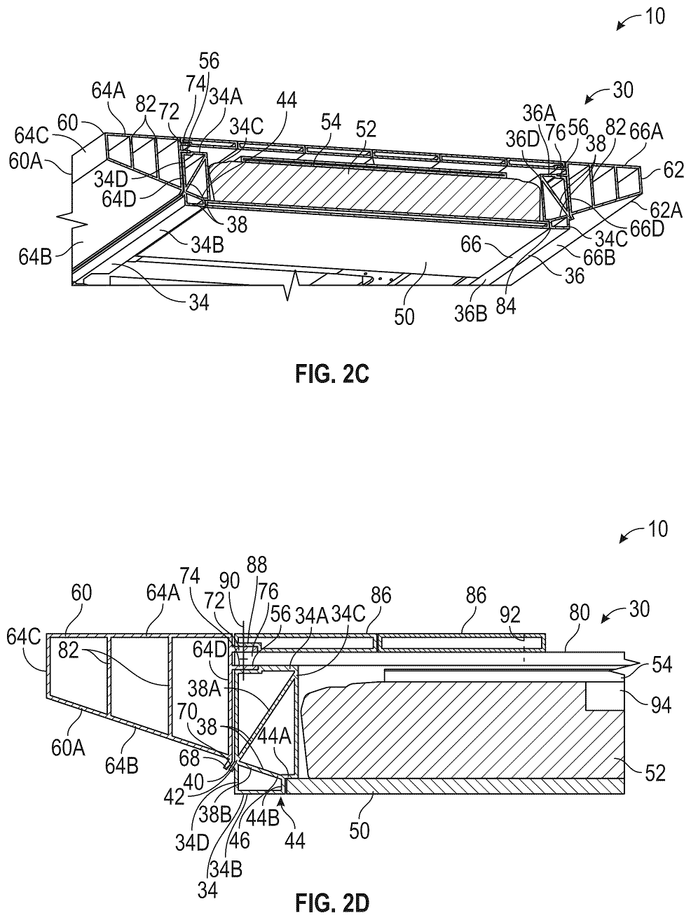

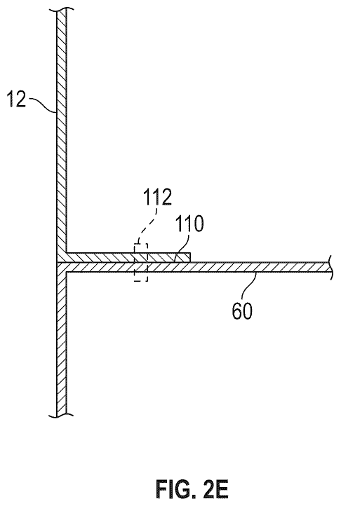

Referring now to FIGS. 2A-2E, a portion of the vehicle 10 is illustrated in greater detail. In FIGS. 2A-2D, the body 12 has been removed. Likewise, other components may also be removed.

The use of continuous profile shapes (e.g. extrusions, continuous cast or strand cast, roll forms) in the construction of a chassis 30 having a longitudinal axis 32 is illustrated. The shapes of the components forming the chassis 30 are combined in a manner that is useful to the requirements of passenger and light commercial vehicles, where combinations of long service life, repairability, low mass, low production tooling costs and flexibility of application type are priorities for a common vehicle construction architecture.

The chassis 30 is formed using a first inner frame member 34 and second inner frame member 36. The inner frame members 34, 36 may be formed as mentioned above. The inner frame members 34, 36 may be formed from a secondary material. The secondary material may be a circulated material. For example, the inner frame members 34, 36 may be formed of recycled aluminum. Aluminum construction is a suitable choice for long life having corrosion resistance, increased cargo carrying due to reduce mass and repairability through straightening, welding if damaged in normal use or in an accident. The use of aluminum for the components may also be provided with or without secondary coatings. Anodizing may also be used to provide a desired appearance or provide additional protection. Although the use of aluminum for the inner frame members 34, 36 is described, other components may also be formed from aluminum. Depending on the location of the components, the highly ductile properties of prior source aluminum alloys may be used. Other components may use secondary materials that are less ductile. Such components for the chassis 30 may include peripheral locations such as bumper beams, crash cans and the like. Some components may also be designed for replacement as sacrificial elements.

The inner frame members 34, 36 may be formed in a similar way having a similar geometry. The inner frame members 34, 36 have upper walls 34A, 36A, lower walls 34B, 36B, an inner wall 340, 36C and an outer wall 34D, 36D. The inner walls 34C, 36C and the outer walls 34D, 36D are vertical walls.

Inner frame members 34, 36 may also have a web 38 disposed therein. The web 38 may provide structural support and may be configured in a manner to be extruded roll formed or the like with the other portions of the inner frame members 34, 36. In this example, the V-shape of the web 38 is angular with the vertex 42 of the angle at the outer walls 34D, 36D. The outer walls 34D, 36D may have a flange 40 that extends at an angle downward and outward from the outer walls 34D, 36D. The flange 40 may be a continuation of at least one portion of the web 38. That is, the flange 40 may extend from the vertex 42 of the web portions at the outer walls 34D, 36D. One portion 38A of the web 38 may extend from the intersection of the upper walls 34A, 36A and the inside wall 34C, 36C. The vertex 42 may have a second portion 38B of the web 38 extending from the vertex 42 to extend toward an integrated support bracket 44. The integrated support bracket 44 has a first portion 44A that extends in a horizontal direction and a second portion 44B that extends in a vertical direction. The portions 44A, 44B intersect at a corner 46. The corner 46 is coupled to a portion of the web 38 which extends to the vertex 42.

The integrated support bracket 44 is an inverted L-shape and is used to support a lower battery plate 50. The lower battery plate 50 extends laterally from the integrated support bracket 44 on one side of the vehicle to the integrated support bracket 44 on the other side of the vehicle. The integrated support bracket 44 may be positioned and sized so that the lower battery plate 50 is flush or nearly flush with the bottom walls 34B, 36B of the inner frame members 34, 36. The lower battery plate 50 may be formed of various materials, such as composite material or aluminum as described above. The lower battery plate 50 is used for supporting a battery 52 and may also be solid as illustrated in FIG. 2D or extruded and hollow as illustrated in FIG. 2C. The battery 52 may be comprised of battery cells 52 and the housing for the battery 52 may be eliminated. However, the batteries 52 may take various forms. That is, the battery 52 may have a battery structural cross member 54 that extends across the battery 52 that may or may not be coupled to the inner frame members 34, 36.

The inner frame members 34, 36 may have a recessed surface 56 that is offset from the walls 34A, 34B. The recessed surface 56 is outboard and vertically below the walls 34A, 36A and extends longitudinally relative to the vehicle 10.

Although the inner frame members 34, 36 may be completely straight or may have raised portions 34E, 36E coupled by an angular portion 34F, 36F to the inner frame members 34, 36. The portions 34E, 36E may be parallel to the remaining portions of the inner frame members 34, 36.

The inner frame members 34, 36 may be disposed inward from outer rocker members 60, 62. That is, the outer rocker members 60, 62 may be directly adjacent and coupled to the inner frame members 34, 36.

The inner rocker members 60, 62 may be a continuously extruded or formed members that extends between a tire and wheel assemblies 14 each side of the vehicle. However, as illustrated in the present example, the outer rocker members 60, 62 may be formed of a front outer rocker member 60A, 62A and a rear outer rocker member 60B, 62B. Front and rear are relative to the longitudinal direction of the vehicle 10. The outer rocker members 60A, 62A may be directly adjacent to the corresponding outer rocker members 60A, 62B. Different grades of materials may be used for the front and rear rocker members. For example, the front outer rocker members 60A, 62A may be formed of a higher crash resistance material have higher ductility than the rear outer rocker portions 60B, 62B. The outer rocker portions 60,A, 62A may be a primary grade material and the rear outer rocker portions 60B, 62B may be formed from recycled material. However, one continuous rocker portion may be used on either side of the vehicle and may be formed of primary grade material.

In this example, the outer rocker members 60, 62 have an upper wall 64A, 66A, a lower side wall 64B, 66B, an outer side wall 64C, 66C and an inner side wall 64D, 66D. In the present example, the walls 64A, 66A are peripheral to the walls 64C, 64D and 66C and 66D, respectively. In the present example, the walls 64B, 66B extend angularly upwardly from the inner frame members 34, 36. In the present example, a flange 68 extends angularly outwardly from the intersection of the walls 64D, 64B and 66D, 66B. The flange 68 may be directly adjacent to the flange 40. That is, a fastener 70 that includes a weld, bolt or rivet may be used to couple the flange 40 and flange 68 together.

The inner walls 64D, 66D have horizontally extending walls 72, 74 extending inwardly therefrom. The horizontally extending walls 72, 74 extend from a position on the walls 64D, 66D in a plane below the walls 64A, 66A of the outer rocker members 60A, 60B 62A, 62B. That is, the horizontally extending wall 72 may be referred to as recessed vertically relative to the walls 64A, 66A.

The walls 72, 74 are spaced apart vertically to form a channel 76 therebetween. The channels 76 are rectangular in shape and are used to receive a top chassis cross member 80. That is, the top chassis cross members 80 may be spaced apart longitudinally and extend laterally across the vehicles from the channels 76 within the outer rocker members 60, 62.

The outer rocker members 60, 62 may include a web 82 for structural rigidity. The webs 82, in this example, are vertically extending walls that are spaced apart. In this example, the webs 82 laterally divide the outer rocker members 60, 62 into thirds.

The recessed surfaces 56 on the inner frame members 34, 36 are sized, in this example, to have the horizontally extending walls 74 positioned therein. That is, the recessed surfaces 56 have a vertical height sized so that the top chassis cross members 80 rest on the upper walls 34A, 36A. Also, the top chassis cross members 80 extend into the channels 76.

As illustrated best in FIG. 2A, at least the cargo compartment 18 may have a plurality of longitudinally extending floor deck plates 86 extending longitudinally in the cargo compartment 18. However, the floor deck plates 86 may extend into the passenger compartment 16 as well. The floor deck plates 86 may also be extruded components. The floor deck plates 86 are supported by the laterally extending top chassis cross members 80. The number of top chassis cross members 80 depends on the condition for which the vehicle will be used and the amount of load on the load floor formed by the floor deck plates 86. The construction of the floor deck plates 86 also contributes to the spacing for the top chassis cross members 80.

The floor deck plates 86 that are disposed directly over the inner frame members 34 and 36 may have an elongated recessed surface 88 that receives the upper horizontal extending walls 72 to allow the floor deck plates 86 to remain planar and flush. That is, the upper surface of the floor desk plate 86 and the upper wall 66A may form a continuous surface that forms the load floor. The upper walls 64A and 66A may be used to secure the body or a portion of the body thereto.

A plurality of fasteners 90 is illustrated that extends through the floor deck plates 86, the horizontal extending wall 72, 74, the top chassis cross member 80 and into the inner frame member 34. The plurality of fasteners 90 may be used to secure the assembly together. A plurality of removable fasteners 92 may be used to secure the floor deck plates 86 to the top chassis cross member 80. The fasteners 92 may be easily removable to allow access to the battery 52 and/or the components associated therewith including various types of control circuitry 94 including regulators, circuit boards and the like. By providing the removal fasteners 92, the floor deck plates 86 may be removed and the faulty components may be replaced without replacing the entire battery 52.

The vehicle may also include a passenger load floor 98 and a rear load floor 100. The load floor 98, 100 may be a stamped material applied under the passenger compartment 16 and the rearmost portion of the cargo compartment 18, respectively.

As illustrated best in FIG. 2B, a rear suspension, in this example, is packaged beneath the floor 100. That is, the rail portions 34E and 36E may be referred to as “kick-up” rail portions that allow the suspension 102 to be positioned thereunder and allow a greater load floor area. Should a larger battery pack be provided, the inner frame members 34, 36 may be higher and the top surfaces may be level with the tops of the frame portions 34E, 36E.

In FIG. 2E, an enlarged cross-sectional view of the body 12 having a flange 108 is used to join the body to the outer rocker member 60. A weld material or adhesive 110, or fastener 112 may be used to fix the body 12 to the outer rocker member 60.

The present vehicle construction has different features that may be used in part or all together depending on the vehicle design needs. One feature includes the use of a single external profile to create a section of structure that can be cut to different lengths for different applications. Another feature is different sectional geometry within a specific external dimensional profile (vary wall thickness internally) may be created to meet specific performance requirement. Also, different grades of material (within a material type or family) may be substituted to meet performance, cost, environmental or regulatory requirements. Further different profile sections and constructions may be combined to meet specific performance requirements aligned to that area of the chassis/frame section. Further external flange profiles support different attachment means to ensure mechanical strength and stiffness characteristics may be shared between profile parts along longitudinal length of the resulting assembly. Continuous profiles may be used through serviceable mechanical means to enable partial replacement, repair or repurposing of the vehicle to reduce repair costs and/or lengthen the usable life of the vehicle. The design allows the flexibility to add or not include specific sections along the length of the chassis/frame profile to allow for content like wheel openings or side impact zones. Further, cavities may be filled or reinforced within the continuous profile to augment performance properties such as stiffness or resistance to crush/collapse loads. Also, profile sections may be mixed with materials that enable secondary machining of key features for interfaces to other vehicle components. The ability to mix profile sections with materials that enable joining processes such as welding of bonding for joining of additional components.

Profile sections may be combined strategically in combination with an EV battery pack to provide a small side view sectional profile and low to ground vehicle chassis/frame that is lightweight, strong and serviceable throughout an extended commercial vehicle lifespan.

In one specific example, a flexible light commercial vehicle architecture includes a pair of secondary (recycled) grade aluminum extrusion rails running the length of the vehicle. These provide basic structural geometry, strength, stiffness and serve as the primary structure to support and protect an EV battery pack. A pair of primary (virgin) grade aluminum (high ductility) extrusions at the outboard sides of the vehicle to reinforce for side impact where this strength is most needed, and to provide additional torsional and bending rigidity/strength through their longitudinal attachment to the inboard rails. The architecture further includes a battery pack whose primary vertical side and top horizontal structure is provided by the vehicle frame extrusions rather than by a separate internal structure. The battery pack that provides a structural lower/bottom plate that provides the assembly base for the battery and the under vehicle protection and shear support between the inner extrusion rails The extrusion section cross members run the width of the vehicle between the longitudinal rails to provide rigidity and load sharing above the battery in side impact conditions and to transfer torsional loads across the two sides of the chassis/frame. These elements may also attach to the inner structural members of the battery pack depending on the dimensional and material requirements. These members may be removeable to allow access to internal battery components without dropping the battery out from the underside of the vehicle. Extrusion section floor decking may run the length of the cargo area, which can be removed to allow access to the power electronics atop the battery for some moderate repair without the need to remove the whole battery pack from the bottom of the vehicle. These components may be fastened to the cross-car elements and the longitudinal elements, further stiffening the torsional performance of the chassis and providing a shear load path across the width of the vehicle's width, in addition to protecting the battery from items loaded on the floor from above. Cut and welded kick-up rail portions of the inner rails allow the vehicle's rear suspension to be packaged beneath the floor. These sections of the longitudinal chassis/frame could be bent, hydroformed, molded or mechanically fastened in alternative concepts. An optional higher-capacity battery pack which raises the load floor height to that of the suspension kick-up is a variant that would provide a flat floor for the entire chassis length and increased range.

The terminology used herein is for the purpose of describing particular example embodiments only and is not intended to be limiting. As used herein, the singular forms “a,” “an,” and “they” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be taken.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a first inner frame member;
a second inner frame member spaced apart from the first inner frame member;
a lower battery plate coupled between the first inner frame member and the second inner frame member;
a plurality of top chassis cross members supported by the first inner frame member and the second inner frame member;
a battery disposed between the first inner frame member, the second inner frame member, the lower battery plate and the plurality of top chassis cross members;
a first outer rocker member adjacent to and outboard of the first inner frame member;
a second outer rocker member adjacent to and outboard of the second inner frame member; and
a floor deck plate supported by the top chassis cross member.

2. The vehicle of claim 1 wherein the first inner frame member and the second inner frame member are extruded, or roll formed.

3. The vehicle of claim 1 wherein the first inner frame member comprises a first integrated support bracket and the second inner frame member comprises a second integrated support bracket, the first integrated support bracket and the second integrated support bracket are coupled to the lower battery plate.

4. The vehicle of claim 3 wherein the first integrated support bracket comprises a vertical portion and a horizonal portion.

5. The vehicle of claim 3 wherein the first inner frame member comprises a web coupled to the first integrated support bracket.

6. The vehicle of claim 5 wherein the web comprises a first portion coupled between the first integrated support bracket and a vertex at a vertical wall of the first inner frame member.

7. The vehicle of claim 6 wherein vertical wall comprises a first flange extending from the vertex and the first outer rocker member comprises a second flange coupled to the first flange.

8. The vehicle of claim 1 wherein the first inner frame member and the second inner frame member are formed of secondary grade material.

9. The vehicle of claim 8 wherein the first outer rocker member and the second outer rocker member are formed of primary grade material.

10. The vehicle of claim 9 wherein lower battery plate is extruded.

11. The vehicle of claim 1 wherein the first outer rocker member comprises a first horizontally extending wall and a second extending wall spaced apart from and below the first horizontally extending wall and forming a channel therebetween.

12. The vehicle of claim 11 wherein the channel receives the plurality of cross members.

13. The vehicle of claim 11 wherein the first horizontally extending wall is disposed below an upper surface of the first outer rocker member.

14. The vehicle of claim 13 wherein the first horizontally extending wall supports a lower surface of the floor deck plate.

15. The vehicle of claim 14 wherein the floor deck plate comprises a plurality of longitudinally extending floor deck plates.

16. The vehicle of claim 15 wherein at least one of the plurality of longitudinally extending floor deck plates comprises an elongated recess disposed against the first horizontally extending wall.

17. The vehicle of claim 15 wherein the plurality of longitudinally extending floor deck plates comprises a fastener coupling the floor deck plates to the first horizontally extending wall at a cross member.

18. The vehicle of claim 17 wherein the plurality of longitudinally extending floor deck plates is coupled to the plurality of top chassis cross members with a removable fastener.

19. The vehicle of claim 1 wherein the first outer rocker comprises a front outer rocker and a rear outer rocker.

20. The vehicle of claim 19 wherein the front outer rocker comprises a higher ductility than rear outer rocker.
